(19) United States
(12) Patent Application Publication
(10) Pub. No.: US 2025/0216276 A1
(43) Pub. Date: Jul. 3, 2025

(54) LOAD SENSOR ELEMENT

(71) Applicant: KOA CORPORATION, Ina-shi, Nagano (JP)

(72) Inventors: Atsushi KARASAWA, Nagano (JP); Natsumi AOKI, Nagano (JP); Masaya TSUNO, Nagano (JP); Hirofumi KOJIMA, Nagano (JP)

(73) Assignee: KOA CORPORATION, Ina-shi, Nagano (JP)

(21) Appl. No.: 18/850,384

(22) PCT Filed: Feb. 10, 2023
(86) PCT No.: PCT/JP2023/004495

§ 371 Date: Sep. 24, 2024

(30) Foreign Application Priority Data
Mar. 25, 2022 (JP) 2022-050869

(51) Int. Cl. G01L 1/22

(52) U.S. Cl. CPC G01L 1/2287

(57) ABSTRACT

A load sensor element include: a substrate; an inorganic layer that is a first layer provided on a front surface that is a first surface of the substrate, the inorganic layer being configured to cover a part of the substrate; and a thin-film resistance body provided on the front surface. The thin-film resistance body has: a main body portion that is sandwiched between the substrate and the inorganic layer; and a first end portion and a second end portion that are mounted on an exposed portion of the substrate that is not covered by the inorganic layer. The load sensor element includes a reinforcing layer that is a second layer provided on a back surface that is a second surface of the substrate so as to sandwich the substrate together with the inorganic layer. In the load sensor element, the inorganic layer and the reinforcing layer are arranged such that an inorganic-layer first end edge of the inorganic layer that is in contact with the front surface and a reinforcing-layer first end edge of the reinforcing layer that is in contact with the back surface are aligned with each other in the thickness direction of the substrate.

### TECHNICAL FIELD

The present invention relates to a load sensor element.

### BACKGROUND ART

JP2021-032805A discloses a load sensor element.

This load sensor element includes: a substrate; a thin-film resistance body that is provided on a surface of the substrate; and an inorganic layer that is provided on the surface of the substrate and arranged so as to cover a main body portion of the thin-film resistance body. On the surface of the substrate, a covered portion that is covered by the inorganic layer and an exposed portion that is not covered by the inorganic layer are formed.

### SUMMARY OF INVENTION

In a state in which such a load sensor element is placed on a flat pedestal of a measurement target, when a load is applied to the inorganic layer, the pedestal may be deformed such that the part receiving the load from the inorganic layer is depressed in response to the load. When the pedestal returns to the original state from the state in which the load is applied, this deformation also returns to the original flat state. In other words, the pedestal is repeatedly deformed each time the load is applied.

Consequently, the substrate is subjected to forces from edges of the depression, and so, the substrate may be deformed such that the exposed portion is lifted off from the pedestal. In this case, stress is concentrated on the boundary between the covered portion and the exposed portion.

An object of the present invention is to enable suppression of concentration of stress generated in a substrate.

A load sensor element of a certain aspect of the present invention is a load sensor element for measuring a surface pressure load. The load sensor element includes: a substrate; and a first layer provided on a first surface of the substrate, the first layer being configured to cover a part of the substrate. The load sensor element includes a thin-film resistance body formed of a resistance body whose resistance value is changed in response to a load received from the first layer, the thin-film resistance body having: a main body portion provided on the first surface and sandwiched between the substrate and the first layer; and both end portions mounted on an exposed portion of the substrate, the exposed portion being not covered by the first layer. The load sensor element includes: a pair of electrodes respectively electrically connected to both end portions of the thin-film resistance body; and a second layer provided on a second surface of the substrate so as to sandwich the substrate together with the first layer. In the load sensor element, the first layer and the second layer are arranged such that an edge of the first layer in contact with the first surface and an edge of the second layer in contact with the second surface are aligned with each other in the thickness direction of the substrate.

According to this aspect, the second layer is provided on the second surface of the substrate of the load sensor element. In addition, the first layer and the second layer are arranged such that an edge of the first layer in contact with the first surface of the substrate and an edge of the second layer in contact with the second surface are aligned with each other in the thickness direction of the substrate.

When this load sensor element is set to the measurement target, the second layer of the load sensor element comes into contact with the pedestal of the measurement target, on which the load sensor element is installed, and a gap is formed between the exposed portion of the substrate, which is not covered by the second layer, and the pedestal.

In this state, even when the load applied to the load sensor element is also applied to the second layer, and the deformation is caused so as to form a depression in the pedestal (hereinafter, it may simply be referred to as a depression), if the depth of the depression is equal to or less than the thickness dimension of the second layer, the substrate is not pushed up by the edge of the depression.

Therefore, it becomes possible to suppress the concentration of the stress generated in the substrate compared with a case in which the edge of the depression in the measurement target comes into contact with the substrate of the load sensor element to deform the substrate, and the stress is concentrated on the boundary between the covered portion and the exposed portion.

### BRIEF DESCRIPTION OF DRAWINGS

FIG. 1 is a perspective view of a load sensor element according to a first embodiment viewed from the front surface side.

FIG. 2 is a diagram showing the load sensor element according to the first embodiment, and is a plan view showing a state in which the load sensor element, from which respective leads are removed, is viewed from the front surface side.

FIG. 3 is a diagram showing the load sensor element according to the first embodiment, and is a plan view showing a state in which the load sensor element, from which respective leads are removed, is viewed from the back surface side.

FIG. 4 is a perspective view of the load sensor element according to a second embodiment viewed from the front surface side.

FIG. 5 is a perspective view of the load sensor element according to a third embodiment viewed from the front surface side.

FIG. 6 is a perspective view of the load sensor element according to a fourth embodiment viewed from the front surface side.

FIG. 7 is a perspective view of the load sensor element according to a fifth embodiment viewed from the front surface side.

FIG. 8 is a diagram showing the load sensor element according to a fifth embodiment, and is a plan view showing a state in which the load sensor element, from which respective leads are removed, is viewed from the front surface side.

FIG. 9 is a diagram showing the load sensor element according to the fifth embodiment, and is a plan view showing a state in which the load sensor element, from which respective leads are removed, is viewed from the back surface side.

FIG. 10 is a circuit diagram showing a usage example of the load sensor element according to the fifth embodiment.

FIG. 11 is a perspective view of the load sensor element according to a sixth embodiment viewed from the back surface side.

### DESCRIPTION OF EMBODIMENTS

In the following, embodiments for carrying out the present invention will be described with reference to the attached drawings.

### First Embodiment

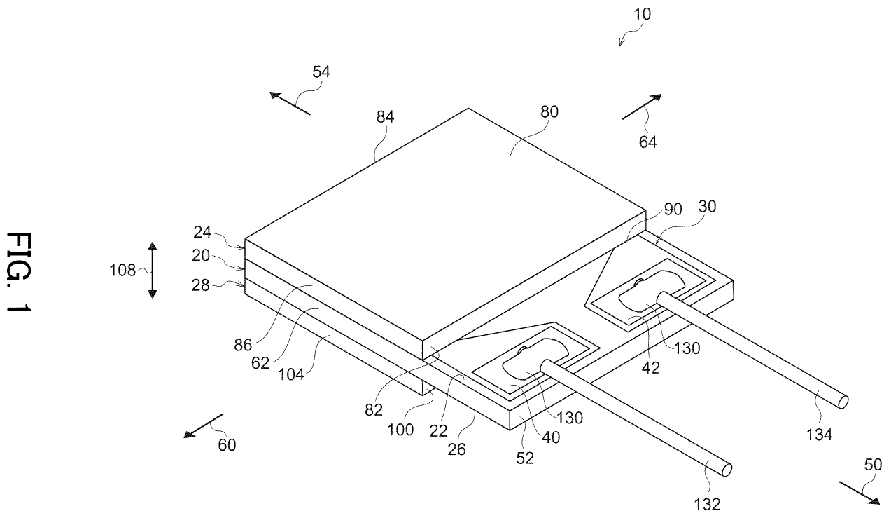

A load sensor element 10 according to a first embodiment will be described first with reference to FIGS. 1 to 3.

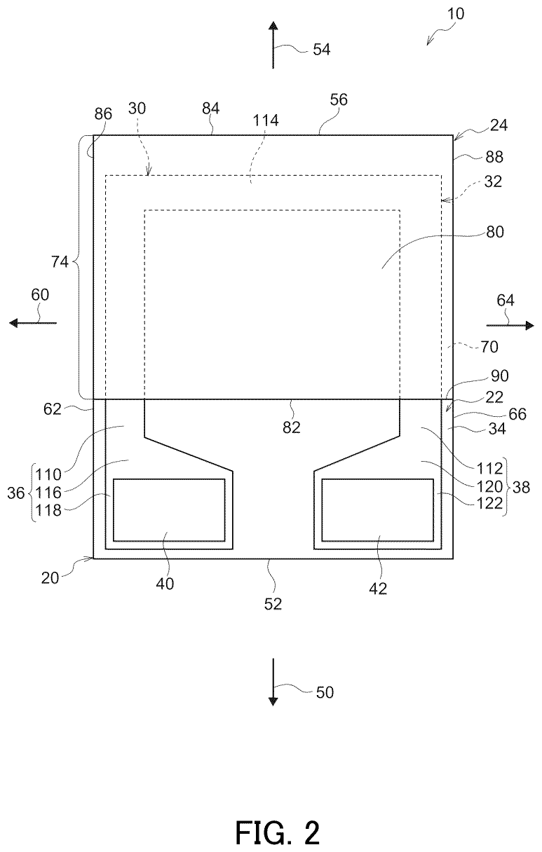

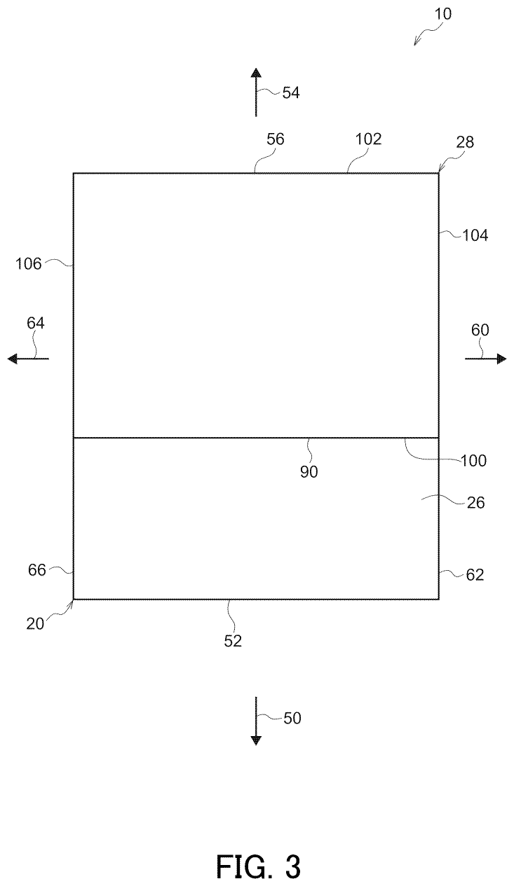

FIG. 1 is a perspective view of the load sensor element 10 according to the first embodiment viewed from the front surface side. FIG. 2 is a diagram showing the load sensor element 10 according to the first embodiment, and is a plan view showing a state in which the load sensor element 10, from which respective leads are removed, is viewed from the front surface side. FIG. 3 is a diagram showing the load sensor element 10 according to the first embodiment, and is a plan view showing a state in which the load sensor element 10, from which respective leads are removed, is viewed from the back surface side.

The load sensor element 10 according to this embodiment is a sensor element for measuring a surface pressure load. The load sensor element 10 is, for example, provided in a machine tool, and is used to detect the load on the machine tool in the machining axis direction for performing preload management.

In this embodiment, a case in which the load sensor element 10 is used in the machine tool is given as an example, but the application of the load sensor element 10 is not limited thereto. The load sensor element 10 according to this embodiment may also be used for other applications.

As shown in FIG. 1, the load sensor element 10 includes: a substrate 20; and an inorganic layer 24 serving as a first layer that is provided on a front surface 22, which is a first surface of the substrate 20, and covers a part of the front surface 22 of the substrate 20. In addition, the load sensor element 10 includes a reinforcing layer 28 serving as a second layer that is provided on a back surface 26, which is a second surface of the substrate 20, so as to sandwich the substrate 20 together with the inorganic layer 24.

As shown in FIG. 2, the load sensor element 10 includes a thin-film resistance body 30 that is provided on the front surface 22 of the substrate 20 and that is formed by a resistance body whose resistance value is changed in response to the load received from the inorganic layer 24. The thin-film resistance body 30 has: a main body portion 32 that is sandwiched between the substrate 20 and the inorganic layer 24; and a first end portion 36 and a second end portion 38 that are arranged on an exposed portion 34 on the front surface 22 of the substrate 20, which is not covered by the inorganic layer 24.

A first electrode 40 is electrically connected to the first end portion 36 of the thin-film resistance body 30. In addition, a second electrode 42 is electrically connected to the second end portion 38 of the thin-film resistance body 30.

### Substrate

The substrate 20 forms a rectangular shape in a plan view. The substrate 20 is formed as a plate having a longitudinally elongated rectangle shape.

An edge of the substrate 20 on a first direction side 50 extending in the lengthwise direction (the longitudinal direction or the longitudinal axial direction) forms a substrate first end edge 52. An edge of the substrate 20 on a second direction side 54 forms a substrate second end edge 56. An edge of the substrate 20 on a first side portion side 60 extending in the widthwise direction (the transverse direction or the lateral axial direction) forms a substrate first side edge 62. An edge of the substrate 20 on a second side portion side 64 forms a substrate second side edge 66.

The substrate 20 is formed of a member having an insulating property, for example. Examples of the member having the insulating property include a glass epoxy substrate in which an epoxy resin is impregnated into a glass woven fabric formed by knitting glass fibers, a metal substrate formed of a metal material having an insulating layer formed on its surface, or a ceramic substrate made of a ceramic material.

The substrate 20 of this embodiment is made of the ceramic material, for example. For the substrate 20, from the viewpoint of improving a compressive strength and to provide the substrate with appropriate flexibility, it is preferable to use the ceramic material containing zirconia (ZrO₂) or alumina (Al₂O₃) as the main component.

The front surface 22 of the substrate 20 has a covered portion 70 having a rectangular shape (including a square shape) that is covered by the inorganic layer 24 and the exposed portion 34 having a rectangular shape, which is not covered by the inorganic layer 24. The covered portion 70 forms a pressure receiving region 74 to which the load is applied when the inorganic layer 24 is pressurized.

### Inorganic Layer

As shown in FIG. 1, the front surface 22 of the inorganic layer 24 forms a pressure receiving surface 80. An entire front surface of the pressure receiving surface 80 is pressed substantially uniformly by the load. The inorganic layer 24 forms a plate having a rectangular shape (including a square shape) in a plan view. The inorganic layer 24 is made of an inorganic material. The material forming the inorganic layer 24 may be the same material as the substrate 20 or may be a material different from the substrate 20.

The inorganic layer 24 is made of the ceramic material having an insulating property, for example. As the inorganic material forming the inorganic layer 24, similarly to the substrate 20, it is preferable to use the inorganic material containing zirconia (ZrO₂) or alumina (Al₂O₃) as the main component.

The inorganic layer 24 may be formed by a lamination method, such as sputtering. The method of forming the inorganic layer 24 can be selected from other formation methods depending on thickness dimension, etc. of the inorganic layer 24.

As shown in FIG. 2, the area of the inorganic layer 24 is smaller than the area of the substrate 20. An edge of the inorganic layer 24 on the first direction side 50 forms an inorganic-layer first end edge 82. An edge of the inorganic layer 24 on the second direction side 54 forms an inorganic-layer second end edge 84. An edge of the inorganic layer 24 on the first side portion side 60 in the widthwise direction forms an inorganic-layer first side edge 86. An edge of the inorganic layer 24 on the second side portion side 64 forms an inorganic-layer second side edge 88.

A boundary line 90 between the covered portion 70 and the exposed portion 34 of the substrate 20 is formed on the substrate 20 by the inorganic-layer first end edge 82 that is one side of the inorganic layer 24 in contact with the first surface of the substrate 20. The inorganic-layer second end edge 84 is positioned above the substrate second end edge 56. The inorganic-layer first side edge 86 is positioned above the substrate first side edge 62. The inorganic-layer second side edge 88 is positioned above the substrate second side edge 66.

The inorganic layer 24 covers the part of the front surface 22 of the substrate 20. The inorganic layer 24 covers a part of the thin-film resistance body 30 (the main body portion 32) that is provided on the substrate 20 and does not cover each of the end portions 36 and 38 (both end portions) of the thin-film resistance body 30.

The inorganic layer 24 is fixed to the substrate 20 by a bonding layer (not shown) made of a resin material. The resin material forming the bonding layer contains an epoxy resin as the main component, for example.

### Reinforcing Layer

As shown in FIG. 3, the reinforcing layer 28 forms a plate having a rectangular shape (including a square shape) in a plan view. The reinforcing layer 28 has the same shape as the inorganic layer 24.

The reinforcing layer 28 has substantially the same size as the inorganic layer 24. The term “the same size” refers to that the degree of magnitude in terms of size is the same (in this embodiment, at least the width and the length are the same).

In addition, the phrase “the reinforcing layer 28 and the inorganic layer 24 have substantially the same size” includes a case in which the size of the reinforcing layer 28 and the size of the inorganic layer 24 are different within a range of variations in size caused in manufacturing.

The reinforcing layer 28 is made of the material of the same type as the inorganic layer 24. The reinforcing layer 28 is made of an inorganic material. The material forming the reinforcing layer 28 may be the material as the substrate 20 or may be a material different from the substrate 20.

The reinforcing layer 28 is made of the ceramic material having an insulating property, for example. As the material for forming the reinforcing layer 28, similarly to the substrate 20, it is preferable to use the ceramic material containing zirconia (ZrO₂) or alumina (Al₂O₃) as the main component.

The reinforcing layer 28 may be formed by a lamination method, such as sputtering. The method of forming the reinforcing layer 28 can be selected from other formation methods depending on the thickness dimension, etc. of the reinforcing layer 28.

The area of the reinforcing layer 28 is smaller than the area of the substrate 20. An edge of the reinforcing layer 28 on the first direction side 50 forms a reinforcing-layer first end edge 100. An edge of the reinforcing layer 28 on the second direction side 54 forms a reinforcing-layer second end edge 102. An edge of the reinforcing layer 28 on the first side portion side 60 in the widthwise direction forms a reinforcing-layer first side edge 104. An edge of the reinforcing layer 28 on the second side portion side 64 forms a reinforcing-layer second side edge 106.

The reinforcing-layer first end edge 100, which is one side of the inorganic layer 24 in contact with the first surface of the substrate 20, is positioned on the line overlapping with the boundary line 90 between the covered portion 70 and the exposed portion 34 of the substrate 20 in the thickness direction 108 of the substrate 20 (see FIG. 1). The reinforcing-layer second end edge 102 is positioned above the substrate second end edge 56. The reinforcing-layer first side edge 104 is positioned above the substrate first side edge 62. The reinforcing-layer second end edge 102 is positioned above the substrate second side edge 66.

The inorganic layer 24 and the reinforcing layer 28 are arranged such that the inorganic-layer first end edge 82 of the inorganic layer 24 that is in contact with the front surface 22 of the substrate 20 (see FIG. 2) and the reinforcing-layer first end edge 100 of the reinforcing layer 28 that is in contact with the back surface 26 (see FIG. 3) are aligned with each other in the thickness direction 108 of the substrate 20.

In this embodiment, although a description will be given of a case in which the inorganic layer 24 and the reinforcing layer 28 have the same shape and have substantially the same size, this embodiment is not limited thereto.

For example, the dimension from the reinforcing-layer first side edge 104 to the reinforcing-layer second side edge 106 of the reinforcing layer 28 is made larger than the dimension from the inorganic-layer first side edge 86 to the inorganic-layer second side edge 88 of the inorganic layer 24. Then, the reinforcing layer 28 may be arranged such that the reinforcing-layer first side edge 104 and the reinforcing-layer second side edge 106 are positioned outside the substrate 20.

The reinforcing layer 28 covers a part of the back surface 26 of the substrate 20. The reinforcing layer 28 covers the back side of the covered portion 70, and does not cover the back side of the exposed portion 34.

The reinforcing layer 28 is fixed to the substrate 20 by a bonding layer (not shown) made of a resin material. The resin material forming the bonding layer contains an epoxy resin as the main component, for example.

### Thin-Layer Resistance Body

As shown in FIG. 2, the thin-film resistance body 30 is the resistance body whose resistance value is changed in response to the load received by the inorganic layer 24. The thin-film resistance body 30 has: the main body portion 32 that is sandwiched between the substrate 20 and the inorganic layer 24; and the first end portion 36 and the second end portion 38 that are linked to the main body portion 32 and that are arranged on the exposed portion 34 of the substrate 20, which is not covered by the inorganic layer 24.

The main body portion 32 of the thin-film resistance body 30 is formed of a portion sandwiched between the substrate 20 and the inorganic layer 24, and the main body portion 32 of the thin-film resistance body 30 is formed of a thin-film joining portion 114, a part of a first thin-film extended portion 110, and a part of a second thin-film extended portion 112.

The thin-film resistance body 30 is made of, for example, nichrome (NiCr) material or chromium (Cr) material. As a result, a temperature coefficient of resistance (TCR) is lowered, and so, the load sensor element 10 can precisely detect the load even in a high temperature environment of 50° C. or higher.

In addition, the thin-film resistance body 30 is a resistive film that is formed in a thin film on the front surface 22 of the substrate 20 by a vacuum process such as a vapor deposition, a sputtering, and so forth. The formation method using sputtering tends to produce films with uniform characteristics and thickness. Therefore, the load sensor element 10, which includes the thin-film resistance body 30 formed as a uniform resistive film by a vacuum process such as a vapor deposition, a sputtering, and so forth, can precisely detect the load.

The thin-film resistance body 30 has the first thin-film extended portion 110 that extends linearly along the substrate first side edge 62. The first thin-film extended portion 110 extends from the first direction side 50 towards the second direction side 54 of the substrate 20. The thin-film resistance body 30 has the second thin-film extended portion 112 that extends linearly along the substrate second side edge 66. The second thin-film extended portion 112 extends from the first direction side 50 towards the second direction side 54 of the substrate 20.

The thin-film resistance body 30 has the thin-film joining portion 114 that joins the first thin-film extended portion 110 and the second thin-film extended portion 112. The thin-film joining portion 114 is arranged on the second direction side 54 of the substrate 20 and extends linearly along the substrate second end edge 56.

With such a configuration, the main body portion 32 of the thin-film resistance body 30 is formed to have a U-shape.

In this embodiment, although a description has been given of a case in which the main body portion 32 is formed to have the U-shape, this embodiment is not limited to this shape. For example, the main body portion 32 may be formed to have a meandering shape with repeated bends.

The first thin-film extended portion 110, the second thin-film extended portion 112, and the thin-film joining portion 114 are set to have substantially the same width dimension.

A first widening portion 116 whose width dimension is increased towards the substrate first end edge 52 is joined to the first direction side 50 of the first thin-film extended portion 110. A first rectangular portion 118 having a rectangular shape is joined to the first widening portion 116.

A second widening portion 120 whose width dimension is increased towards the substrate first end edge 52 is joined to the first direction side 50 of the second thin-film extended portion 112. A second rectangular portion 122 having a rectangular shape is joined to the second widening portion 120.

The thin-film joining portion 114, a part of the first thin-film extended portion 110, and a part of the second thin-film extended portion 112 of the thin-film resistance body 30 form the main body portion 32 that is covered by the inorganic layer 24.

A part of the first thin-film extended portion 110, the first widening portion 116, and the first rectangular portion 118 of the thin-film resistance body 30 form the first end portion 36 that is not covered by the inorganic layer 24. In addition, a part of the second thin-film extended portion 112, the second widening portion 120, and the second rectangular portion 122 of the thin-film resistance body 30 form the second end portion 38 that is not covered by the inorganic layer 24.

For example, the first electrode 40 having a rectangular shape (including a square shape) is provided on the first rectangular portion 118 of the thin-film resistance body 30. The first electrode 40 is electrically connected to the first rectangular portion 118 and is arranged on the first direction side 50 of the substrate 20.

In addition, for example, the second electrode 42 having a rectangular shape (including a square shape) is provided on the second rectangular portion 122 of the thin-film resistance body 30. The second electrode 42 is electrically connected to the second rectangular portion 122 and is arranged on the first direction side 50 of the substrate 20.

The electrodes 40 and 42 are each made of, for example, a material such as, for example, copper (Cu), silver (Ag), gold (Au), and so forth. The electrodes 40 and 42 are formed on the first rectangular portion 118 of the thin-film resistance body 30 and the second rectangular portion 122 of the thin-film resistance body 30, respectively, by a method such as sputtering, vapor deposition, or the like. The first electrode 40 and the second electrode 42 are formed to have smaller dimensions than the first rectangular portion 118 of the thin-film resistance body 30 and the second rectangular portion 122 of the thin-film resistance body 30, respectively.

As shown in FIG. 1, a first lead wire 132 is connected to the first electrode 40 by a solder 130. A second lead wire 134 is connected to the second electrode 42 by the solder 130.

Each of the lead wires 132 and 134 is made of a material such as, for example, a copper (Cu)-based alloy, an iron (Fe)-based alloy, and so forth. Each of the lead wires 132 and 134 is formed of, for example, an uncovered conductive wire (a metal wire plated with tin (Sn), etc.), a covered wire in which the conductive wire is covered by a covering, an enamel wire in which the conductive wire is covered with the insulating layer, or the like. In addition, a terminal formed of a flat lead frame may also be used.

### Operations and Effects

Next, operational advantages achieved by the first embodiment will be described.

The load sensor element 10 of this embodiment is the load sensor element for measuring the surface pressure load. The load sensor element 10 includes: the substrate 20; and the inorganic layer 24 serving as the first layer that is provided on the front surface 22 that is the first surface of the substrate 20 and that covers a part of the substrate 20. The load sensor element 10 includes the thin-film resistance body 30 that is the resistance body whose resistance value is changed in response to the load received from the inorganic layer 24 and that is provided on the front surface 22. The thin-film resistance body 30 has: the main body portion 32 that is sandwiched between the substrate 20 and the inorganic layer 24; and the first end portion 36 and the second end portion 38 that are arranged on the exposed portion 34 of the substrate 20, which is not covered by the inorganic layer 24. The load sensor element 10 includes: the first electrode 40 and the second electrode 42 that are electrically connected to the first end portion 36 and the second end portion 38 of the thin-film resistance body 30, respectively; and the reinforcing layer 28 serving as the second layer that is provided on the back surface 26 that is the second surface of the substrate 20 so as to sandwich the substrate 20 together with the inorganic layer 24. In the load sensor element 10, the inorganic layer 24 and the reinforcing layer 28 are arranged such that the inorganic-layer first end edge 82 of the inorganic layer 24 that is in contact with the front surface 22 and the reinforcing-layer first end edge 100 of the reinforcing layer 28 that is in contact with the back surface 26 are aligned with each other in the thickness direction 108 of the substrate 20.

In this configuration, the reinforcing layer 28 is provided on the back surface 26 of the substrate 20 of the load sensor element 10. In addition, the inorganic layer 24 and the reinforcing layer 28 are arranged such that the inorganic-layer first end edge 82 of the inorganic layer 24 that is in contact with the front surface 22 of the substrate 20 and the reinforcing-layer first end edge 100 of the reinforcing layer 28 that is in contact with the back surface 26 are aligned with each other in the thickness direction 108 of the substrate 20.

Therefore, when the load is measured, the reinforcing layer 28 of the load sensor element 10 comes into contact with the pedestal of the measurement target, on which the load sensor element 10 is installed, and a gap is formed between the exposed portion of the substrate 20, which is not covered by the reinforcing layer 28, and the pedestal.

In this state, even when the load applied to the load sensor element 10 is also applied to the reinforcing layer 28, and the deformation is caused so as to form the depression in the pedestal, if the depth of the depression formed by the deformation is equal to or less than the thickness dimension of the reinforcing layer 28, the edge of the depression caused by the deformation does not lift up the substrate 20. As a result, it is possible to suppress the deformation of the substrate 20 due to the substrate 20 being lifted up by the edge of the depression formed by the deformation.

Therefore, it becomes possible to suppress the concentration of the stress generated in the substrate 20 compared with a case in which the edge of the depression formed by the deformation comes into contact with the substrate 20 to deform the substrate 20, and the stress is concentrated on the boundary line 90 between the covered portion 70 and the exposed portion 34 of the substrate 20.

In addition, the inorganic layer 24 and the reinforcing layer 28 are arranged such that the inorganic-layer first end edge 82 of the inorganic layer 24 that is in contact with the front surface 22 of the substrate 20 and the reinforcing-layer first end edge 100 of the reinforcing layer 28 that is in contact with the back surface 26 are aligned with each other in the thickness direction 108 of the substrate 20.

Therefore, compared with a case in which the position at which the inorganic-layer first end edge 82 comes into contact with the substrate 20 is different from the position at which the reinforcing-layer first end edge 100 comes into contact with the substrate 20, it is possible to suppress the stress concentration on the position to which the inorganic-layer first end edge 82 comes into contact or the position to which the reinforcing-layer first end edge 100 comes into contact.

In addition, compared with a case in which the stress concentration is repeatedly applied to the boundary line 90 of the substrate 20, it becomes possible to suppress, in advance, breakage of the substrate 20 along the boundary line 90, disconnection at the thin-film resistance body 30 portion across the boundary line 90, and so forth. As a result, it is possible to achieve improvement of a durability of the load sensor element 10.

Furthermore, because the deformation of the substrate 20 due to the stress concentration on the boundary line 90 is suppressed, it becomes possible to accurately and precisely detect only the change in the resistance value when the thin-film resistance body 30 is compressed by the load.

In addition, in the load sensor element 10 of this embodiment, the inorganic layer 24 serving as the first layer has substantially the same size as the reinforcing layer 28 serving as the second layer.

In the load sensor element 10 having such a configuration, because the inorganic layer 24 and the reinforcing layer 28 have substantially the same size, compared with a case in which the inorganic layer 24 and the reinforcing layer 28 have different sizes, it becomes possible to achieve simplification of the manufacture of the inorganic layer 24 and the reinforcing layer 28.

In addition, compared with a case in which the length dimension from the reinforcing-layer first side edge 104 to the reinforcing-layer second side edge 106 of the reinforcing layer 28 is made longer than the length dimension from the inorganic-layer first side edge 86 to the inorganic-layer second side edge 88 of the inorganic layer 24, it is possible to suppress the material cost of the reinforcing layer 28 and to achieve cost reduction.

In addition, in this embodiment, the inorganic layer 24 serving as the first layer and the reinforcing layer 28 serving as the second layer are made of the material of the same type.

In this configuration, because the inorganic layer 24 and the reinforcing layer 28 are made of the material of the same type, compared with a case in which the inorganic layer 24 and the reinforcing layer 28 are made of materials of different types, it is possible to suppress a procurement cost of the material and to achieve cost reduction.

In addition, the inorganic layer 24 and the reinforcing layer 28 are made of the material of the same type. Therefore, when the load is applied, the behavior of the inorganic layer 24 caused on the front surface 22 of the substrate 20 and the behavior of the reinforcing layer 28 caused on the back surface 26 of the substrate 20 can be made consistent.

Specifically, when the inorganic layer 24 and the reinforcing layer 28 are subjected to the same load, they are compressed by the same degree, and when the load is removed, the inorganic layer 24 and the reinforcing layer 28 return in the same manner. Therefore, respective positional relationships between the edges of the inorganic layer 24 and the reinforcing layer 28 (the inorganic-layer first end edge 82 and the reinforcing-layer first end edge 100, the inorganic-layer second end edge 84 and the reinforcing-layer second end edge 102, the inorganic-layer first side edge 86 and the reinforcing-layer first side edge 104, and the inorganic-layer second side edge 88 and the reinforcing-layer second side edge 106) do not change. As a result, compared with a case in which the respective positional relationships between the edges of the inorganic layer 24 and the reinforcing layer 28 are changed, it is possible to keep high strength of the load sensor element 10.

### Second Embodiment

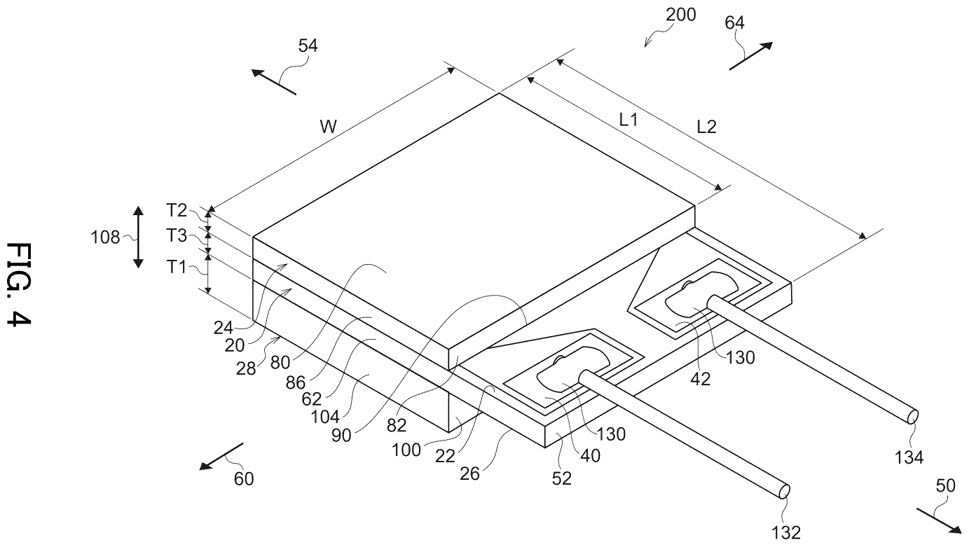

A load sensor element 200 according to a second embodiment will be described with reference to FIG. 4. In this embodiment, components that are the same as or equivalent to those in the first embodiment are assigned the same reference numerals as the first embodiment, and a description thereof shall be omitted and only differences from those in the first embodiment will be described.

FIG. 4 is a perspective view of the load sensor element 200 according to the second embodiment viewed from the front surface side. Compared with the first embodiment, the load sensor element 200 according to the second embodiment is different in the thickness dimension of the reinforcing layer 28.

In the load sensor element 200 according to this embodiment, the thickness dimension T1 of the reinforcing layer 28 serving as the second layer is greater than the thickness dimension T2 of the inorganic layer 24 serving as the first layer.

The inorganic layer 24 may be formed by a lamination method, such as sputtering. By forming the inorganic layer 24 by a lamination method, such as sputtering, it is possible to make the thickness dimension T2 of the inorganic layer 24 and the thickness dimension T1 of the reinforcing layer 28 different with ease.

Specifically, the substrate 20, the reinforcing layer 28, and the inorganic layer 24 have the same width dimension W in the widthwise direction, and the width dimension W is, for example, 4 mm or more and 15 mm or less.

The reinforcing layer 28 and the inorganic layer 24 have the same length dimension L1 in the lengthwise direction, and the length dimension L1 is, for example, 4 mm or more and 15 mm or less. In addition, the length dimension L2 of the substrate 20 is, for example, L1 or more and 20 mm or less. The pressure receiving area formed by the pressure receiving surface 80 of the inorganic layer 24 is, for example, 60 mm² or more and 70 mm² or less.

In addition, the thickness dimension T1 of the reinforcing layer 28 is, for example, 0.1 mm or more and 5.0 mm or less. In this embodiment, the thickness dimension T1 of the reinforcing layer 28 is, for example, 1.0 mm. The thickness dimension T2 of the inorganic layer 24 is, for example, 0.1 mm or more and 5.0 mm or less. In this embodiment, the thickness dimension T2 of the inorganic layer 24 is, for example, 0.3 mm. The thickness dimension T3 of the substrate 20 is, for example, 0.1 mm or more and 5.0 mm or less. In this embodiment, the thickness dimension T3 of the substrate 20 is, for example, 0.3 mm.

Each of these dimensions shows an example thereof, and this embodiment is not limited to these dimensions.

### Operations and Effects

Next, operational advantages achieved by the second embodiment will be described.

Also in this embodiment, for components that are the same as or equivalent to those in the first embodiment, it is possible to achieve operational advantages similar to those of the first embodiment.

In addition, in the load sensor element 200 of this embodiment, the thickness dimension T1 of the reinforcing layer 28 serving as the second layer is greater than the thickness dimension T2 of the inorganic layer 24 serving as the first layer.

In this configuration, when the deformation of the pedestal of the measurement target, on which the load sensor element 200 is installed, is equal to or less than the thickness dimension T1 of the reinforcing layer 28, it is possible to suppress the deformation of the thin-film resistance body 30 portion that is arranged over the boundary line 90 of the substrate 20.

Therefore, by increasing the thickness dimension T1 of the reinforcing layer 28 so as to be greater than the thickness dimension T2 of the inorganic layer 24, it is possible to increase deformation suppressing effect for the substrate 20.

### Third Embodiment

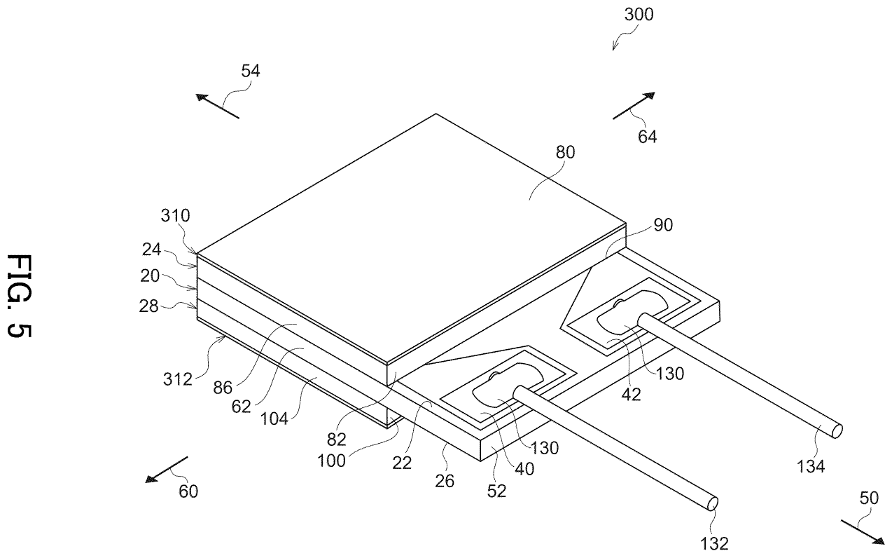

A load sensor element 300 according to a third embodiment will be described with reference to FIG. 5. In this embodiment, components that are the same as or equivalent to those in the first embodiment are assigned the same reference numerals as the first embodiment, and a description thereof shall be omitted and only differences from those in the first embodiment will be described.

FIG. 5 is a perspective view of the load sensor element 300 according to the third embodiment viewed from the front surface side. Compared with the first embodiment, the load sensor element 300 according to the third embodiment is different in the structures of the inorganic layer 24 and the reinforcing layer 28.

The load sensor element 300 according to this embodiment has an outer layer having a lower elastic modulus than the substrate 20 on at least one of an outer surface (the pressure receiving surface 80) of the inorganic layer 24 serving as the first layer and an outer surface of the reinforcing layer 28 serving as the second layer.

In the above description, the outer surface refers to the surface facing outward, that is, the surface opposite to the substrate 20.

In addition, the elastic modulus is the ratio of the increment of stress to the increment of strain, and is expressed by the equation “Elastic Modulus=(Stress)/(Strain)”. Materials with a higher elastic modulus are harder, while materials with a lower elastic modulus are softer.

In the load sensor element 300 of this embodiment, a first outer layer 310 is formed on the entire outer surface of the inorganic layer 24 opposite to the substrate 20. The first outer layer 310 is formed of a resin film made of a synthetic resin.

As the synthetic resin forming the first outer layer 310, a resin material, such as polyimide, PET. or the like, having a lower elastic modulus than the ceramic material forming the substrate 20 is used.

In addition, a second outer layer 312 is formed on the entire outer surface of the reinforcing layer 28 opposite to the substrate 20. The second outer layer 312 is formed of a resin film made of a synthetic resin. As the synthetic resin forming the second outer layer 312, a resin material, such as polyimide, PET. or the like, having a lower elastic modulus than the ceramic material forming the substrate 20 is used.

The first outer layer 310 and the second outer layer 312 are preferably made of the same material, but they may be made of different materials.

### Operations and Effects

Next, operational advantages achieved by the third embodiment will be described.

Also in this embodiment, for components that are the same as or equivalent to those in the first embodiment, it is possible to achieve operational advantages similar to those of the first embodiment.

In addition, in this embodiment, the load sensor element 300 has the first outer layer 310 or the second outer layer 312 having a lower elastic modulus than the substrate 20 on at least one of the outer surface of the inorganic layer 24 serving as the first layer and the outer surface of the reinforcing layer 28 serving as the second layer.

Specifically, in the load sensor element 300 of this embodiment, the first outer layer 310 is formed on the outer surface of the inorganic layer 24, and the second outer layer 312 is formed on the outer surface of the reinforcing layer 28.

In this configuration, it is possible to improve the output characteristics of the load sensor element 300.

This effect will be described specifically.

The substrate 20, the inorganic layer 24, and the reinforcing layer 28, which are made of ceramics, are likely to cause warpage and undulation during the manufacturing process. In addition, fine protruding portions and recessed portions may be formed on the front surface 22 of the substrate 20, an inner surface of the inorganic layer 24, and an inner surface of the reinforcing layer 28.

For example, in a case in which the inorganic layer 24 having a plate shape is arranged on the front surface 22 of the substrate 20, and the load is applied to the thin-film resistance body 30 on the substrate 20, a large force is applied to the parts of the thin-film resistance body 30 positioned above the protruding portions of the front surface 22. In addition, a smaller force is applied to the parts of the thin-film resistance body 30 positioned above the recessed portions of the front surface 22 as compared with the protruding portions.

When the load applied to the thin-film resistance body 30 is released, in the thin-film resistance body 30, the resistance value returns rapidly at parts, to which a smaller force has been applied, whilst the resistance value returns with a delay at parts, to which a larger force has been applied.

Consequently, the response behavior of the stress-resistance value does not become the same for the process of applying the load and the process of releasing the load, and the hysteresis tends to be increased.

Thus, in the load sensor element 300 of this embodiment, the first outer layer 310 having a lower elastic modulus than the substrate 20 is formed on the outer surface of the inorganic layer 24, and the second outer layer 312 having a lower elastic modulus than the substrate 20 is formed on the outer surface of the reinforcing layer 28.

With such a configuration, when the load is applied to the inorganic layer 24, the first outer layer 310 having a lower elastic modulus than the substrate 20 functions as a buffer material that deforms largely at the protruding portions where it is subjected to a larger force. Therefore, it becomes possible to make the load applied to the thin-film resistance body 30 on the substrate 20 uniform. Therefore, it is possible to improve the output characteristics of the load sensor element 300.

In this embodiment, although a description has been given of a case in which the first outer layer 310 is provided on the inorganic layer 24 and the second outer layer 312 is provided on the reinforcing layer 28, this embodiment is not limited thereto. The aforementioned effects can be obtained by forming either of the outer layers 310 and 312 on at least one of the outer surface of the inorganic layer 24 and the outer surface of the reinforcing layer 28.

### Fourth Embodiment

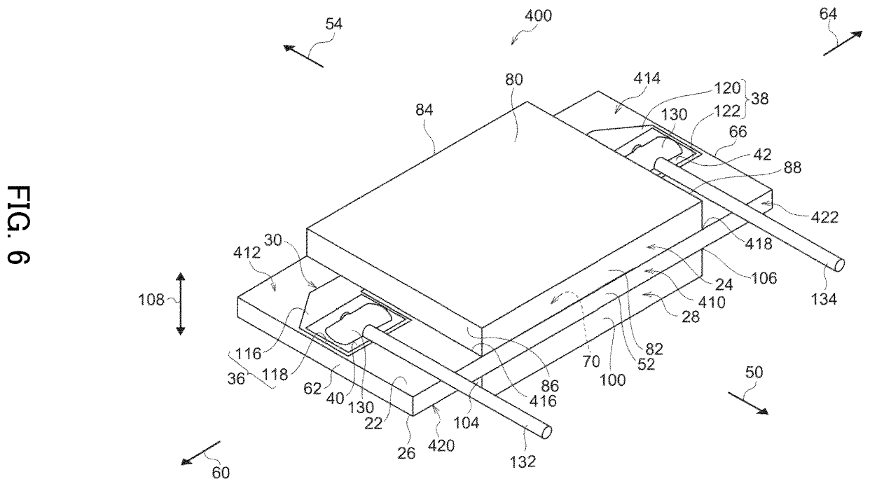

A load sensor element 400 according to a fourth embodiment will be described with reference to FIG. 6. In this embodiment, components that are the same as or equivalent to those in the first embodiment are assigned the same reference numerals as the first embodiment, and a description thereof shall be omitted and only differences from those in the first embodiment will be described.

FIG. 6 is a perspective view of the load sensor element 400 according to the fourth embodiment viewed from the front surface side. Compared with the first embodiment, the load sensor element 400 according to the fourth embodiment differs from the first embodiment in the arrangement of the first electrode 40 and the second electrode 42 that are provided on the thin-film resistance body 30.

### Substrate

A substrate 410 according to this embodiment is formed to have a horizontally elongated rectangle shape.

The front surface 22 of the substrate 410 has the covered portion 70 that is covered by the inorganic layer 24 and a first exposed portion 412 and a second exposed portion 414 that are not covered by the inorganic layer 24.

The first exposed portion 412 is formed on the substrate first side edge 62 side of the substrate 410. A first boundary line 416 is formed between the covered portion 70 and the first exposed portion 412. The second exposed portion 414 is formed on the substrate second side edge 66 side of the substrate 410. A second boundary line 418 is formed between the covered portion 70 and the second exposed portion 414.

### Inorganic Layer

The inorganic-layer first end edge 82 of the inorganic layer 24 is positioned above the substrate first end edge 52 of the substrate 410. The inorganic-layer second end edge 84 is positioned above the substrate second end edge 56 (not shown). The inorganic-layer first side edge 86 is positioned above the first boundary line 416 of the substrate 410. The inorganic-layer second side edge 88 is positioned above the second boundary line 418 of the substrate 410.

The inorganic layer 24 covers the main body portion 32 of the thin-film resistance body 30 (not shown) provided on the substrate 410, and does not cover the first end portion 36 and the second end portion 38 of the thin-film resistance body 30.

### Reinforcing Layer

The reinforcing-layer first end edge 100 of the reinforcing layer 28 is positioned on a line overlapping with the substrate first end edge 52 of the substrate 410 in the thickness direction 108. The reinforcing-layer second end edge 102 (not shown) is positioned on a line overlapping with the substrate second end edge 56 (not shown) in the thickness direction 108. The reinforcing-layer first side edge 104 is positioned on a line overlapping with the first boundary line 416 of the substrate 410 in the thickness direction 108 of the substrate 410. The reinforcing-layer second side edge 106 is positioned on a line overlapping with the second boundary line 418 of the substrate 410 in the thickness direction 108 of the substrate 410.

The inorganic layer 24 and the reinforcing layer 28 are arranged such that the inorganic-layer first side edge 86 of the inorganic layer 24 in contact with the front surface 22 of the substrate 410 and the reinforcing-layer first side edge 104 of the reinforcing layer 28 in contact with the back surface 26 are aligned with each other in the thickness direction 108 of the substrate 410. In addition, the inorganic layer 24 and the reinforcing layer 28 are arranged such that the inorganic-layer first end edge 82 of the inorganic layer 24 in contact with the front surface 22 of the substrate 410 and the reinforcing-layer first end edge 100 of the reinforcing layer 28 that is in contact with the back surface 26 (not shown) are aligned with each other in the thickness direction 108 of the substrate 410.

The reinforcing layer 28 covers a part of the back surface 26 of the substrate 410. The reinforcing layer 28 covers the back side of the covered portion 70 and does not cover the back side of the first exposed portion 412 and the second exposed portion 414.

### Thin-Film Resistance Body

The thin-film resistance body 30 has: the main body portion 32 (not shown) that is sandwiched between the substrate 410 and the inorganic layer 24; and the first end portion 36 that is arranged on the first exposed portion 412 of the substrate 410, which is not covered by the inorganic layer 24. The thin-film resistance body 30 has the second end portion 38 that is arranged on the second exposed portion 414 of the substrate 410, which is not covered by the inorganic layer 24.

Because the main body portion 32 of the thin-film resistance body 30 is covered by the inorganic layer 24, it is not shown in FIG. 6.

In the thin-film resistance body 30, the first widening portion 116 and the first rectangular portion 118 form the first end portion 36 that is not covered by the inorganic layer 24. In addition, in the thin-film resistance body 30, the second widening portion 120 and the second rectangular portion 122 form the second end portion 38 that is not covered by the inorganic layer 24.

The first electrode 40 having a rectangular shape is provided on the first rectangular portion 118 of the thin-film resistance body 30. The first electrode 40 is electrically connected to the first rectangular portion 118 and is arranged on the substrate first side edge 62 side.

The second electrode 42 having a rectangular shape is provided on the second rectangular portion 122 of the thin-film resistance body 30. The second electrode 42 is electrically connected to the second rectangular portion 122 and is arranged on the substrate second side edge 66 side.

The first lead wire 132 is connected to the first electrode 40 by the solder 130. The first lead wire 132 extends along the inorganic-layer first side edge 86 of the inorganic layer 24.

The second lead wire 134 is connected to the second electrode 42 by the solder 130. The second lead wire 134 extends along the inorganic-layer second side edge 88 of the inorganic layer 24.

### Operations and Effects

Next, operational advantages achieved by the fourth embodiment will be described.

Also in this embodiment, for components that are the same as or equivalent to those in the first embodiment, it is possible to achieve operational advantages similar to those of the first embodiment.

In addition, in the load sensor element 400 of this embodiment, the exposed portion has the first exposed portion 412 that is formed on a first side portion 420 of the substrate 410 and the second exposed portion 414 that is formed on a second side portion 422 of the substrate 410. The first end portion 36 serving as a first-side end portion of the thin-film resistance body 30 is arranged on the first exposed portion 412, and the second end portion 38 serving as a second-side end portion of the thin-film resistance body 30 is arranged on the second exposed portion 414. A pair of electrodes provided on the thin-film resistance body 30 include the first electrode 40 provided on the first end portion 36 serving as the first-side end portion and the second electrode 42 provided on the second end portion 38 serving as the second-side end portion.

In this configuration, in a state in which the load sensor element 400 is sandwiched by the measurement target, a gap corresponding to the thickness of the inorganic layer 24 is formed between a pressing surface of the measurement target, which comes into contact with the pressure receiving surface 80 of the inorganic layer 24, and the front surface 22 of the substrate 410, on which respective electrodes 40 and 42 are provided.

Therefore, compared with a case in which the substrate 410 of the load sensor element 400 is close to the pressing surface of the measurement target, it is possible to protect, from the pressing surface, respective bonding portions between the electrodes 40 and 42 and the lead wires 132 and 134 and the lead wires 132 and 134 respectively extending from the electrodes 40 and 42.

In addition, because it is possible to suppress the contact of the bonding portions and each of the lead wires 132 and 134 with the pressing surface, it is possible to prevent, in advance, issues due to a short circuit of an output, etc. which may occur when the pressing surface is formed of a conductor such as a metal, etc.

Because it is possible to suppress interference between the pressing surface and the bonding portions and each of the lead wires 132 and 134 without moving each of the electrodes 40 and 42 away from the inorganic layer 24, it is possible to reduce the size of the load sensor element 400. In addition, because restrictions on arrangement of the electrodes 40 and 42 are reduced, the degree of freedom of design is increased.

In this embodiment, although a description has been given of a case in which a tip end portion of the first lead wire 132 is soldered to the first electrode 40 and a tip end portion of the second lead wire 134 is soldered to the second electrode 42, this embodiment is not limited thereto.

For example, flat plate-shaped terminals that sandwich corresponding electrodes 40 and 42 together with the substrate 410 may be respectively provided on tip end portions of the lead wires 132 and 134. With such a configuration, by sandwiching the corresponding electrodes 40 and 42 between the flat plate-shaped terminals and the substrate 410, it is possible to respectively electrically connect the electrodes 40 and 42 with the lead wires 132 and 134.

In this case, it is possible to reduce the height of the load sensor element 400, to which the respective lead wires 132 and 134 are attached.

### Fifth Embodiment

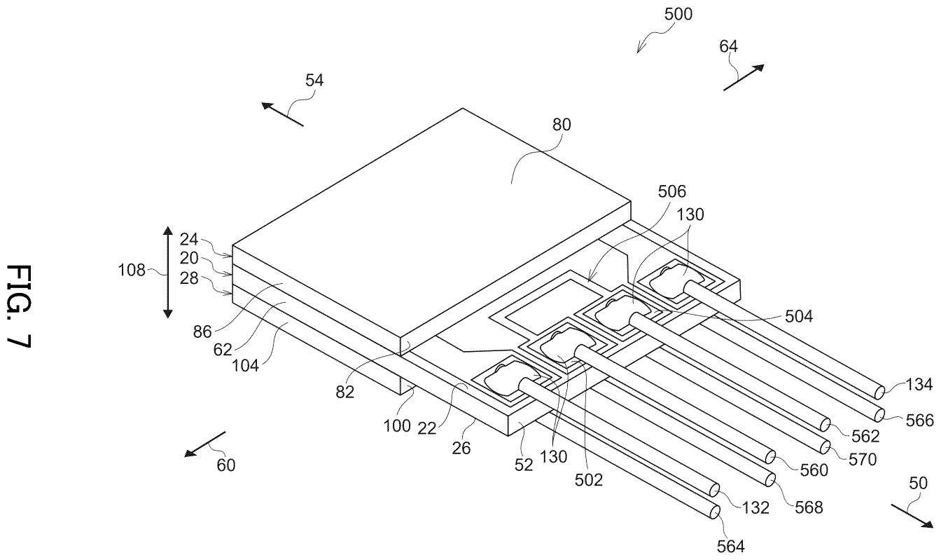

A load sensor element 500 according to a fifth embodiment will be described with reference to FIGS. 7 to 10. In this embodiment, components that are the same as or equivalent to those in the first embodiment are assigned the same reference numerals as the first embodiment, and a description thereof shall be omitted and only differences from those in the first embodiment will be described.

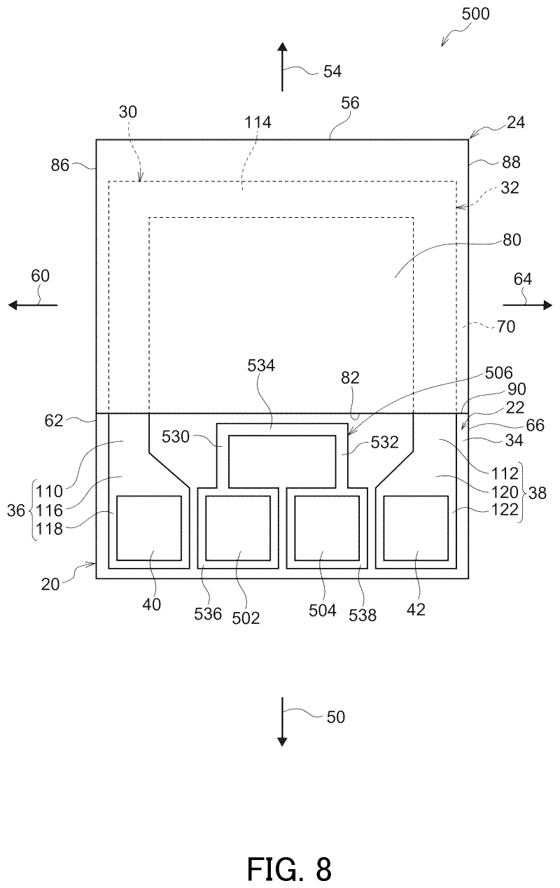

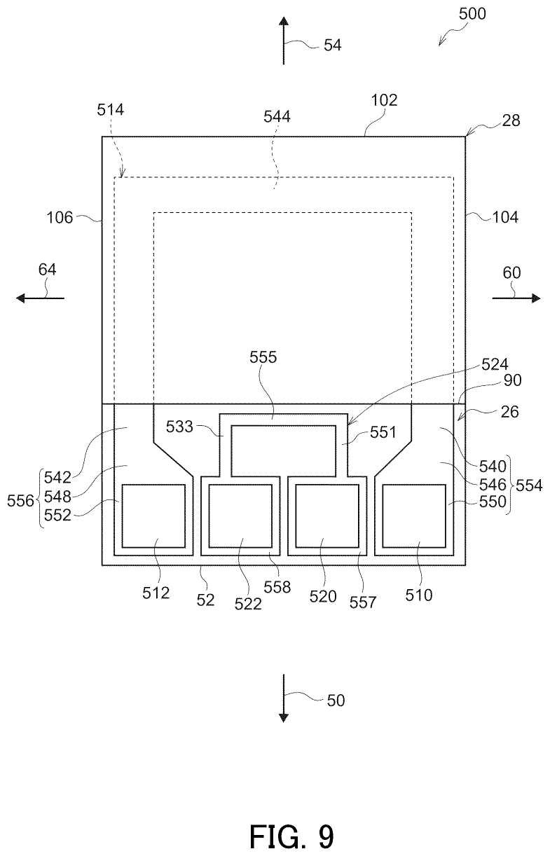

FIG. 7 is a perspective view of the load sensor element 500 according to the fifth embodiment viewed from the front surface side. FIG. 8 is a diagram showing the load sensor element 500 according to the fifth embodiment, and is a plan view showing a state in which the load sensor element 500, from which respective leads are removed, is viewed from the front surface side. FIG. 9 is a diagram showing the load sensor element 500 according to the fifth embodiment, and is a plan view showing a state in which the load sensor element 500, from which respective leads are removed, is viewed from the back surface side.

Compared with the first embodiment, the load sensor element 500 according to the fifth embodiment is different in the number of the resistance bodies provided on the substrate 20.

As shown in FIG. 8, a first resistance body 506 having, at its end portions, a third electrode 502 and a fourth electrode 504 is provided on the front surface 22 that is the first surface of the substrate 20 of the load sensor element 500.

As shown in FIG. 9, a second resistance body 514 having, at its end portions, a fifth electrode 510 and a sixth electrode 512 and a third resistance body 524 having, at its end portions, a seventh electrode 520 and a eighth electrode 522 are provided on the back surface 26 that is the second surface of the substrate 20.

### First Resistance Body

As shown in FIG. 8, the first resistance body 506 is arranged on the exposed portion 34 of the substrate 20 in a state independent from and not electrically or physically connected to the thin-film resistance body 30. The first resistance body 506 is arranged between the first end portion 36 and the second end portion 38 of the thin-film resistance body 30.

The first resistance body 506 is made of the same material as the thin-film resistance body 30. In addition, the first resistance body 506 is formed on the substrate 20 by the same method as the thin-film resistance body 30.

The first resistance body 506 has a first front-surface extended portion 530 and a second front-surface extended portion 532 that extend linearly from the first direction side 50 towards the second direction side 54 in the exposed portion 34 of the substrate 20. The first front-surface extended portion 530 and the second front-surface extended portion 532 are arranged apart from each other.

The first front-surface extended portion 530 is arranged at a position closer to the first end portion 36 of the thin-film resistance body 30 than the second front-surface extended portion 532. The second front-surface extended portion 532 is arranged at a position closer to the second end portion 38 of the thin-film resistance body 30 than the first front-surface extended portion 530.

The first resistance body 506 has a front-surface joining portion 534 that joins the second direction side 54 of the first front-surface extended portion 530 and the second direction side 54 of the second front-surface extended portion 532. The front-surface joining portion 534 extends linearly along the boundary line 90 between the covered portion 70 and the exposed portion 34. With such a configuration, the first resistance body 506 is formed to have a U-shape.

A third rectangular portion 536 having a rectangular shape (including a square shape) is joined to an end portion of the first front-surface extended portion 530 on the first direction side 50. A fourth rectangular portion 538 having a rectangular shape (including a square shape) is joined to an end portion of the second front-surface extended portion 532 on the first direction side 50.

The third electrode 502 having a rectangular shape (including a square shape) is provided on the third rectangular portion 536 of the first resistance body 506. The third electrode 502 is electrically connected to the third rectangular portion 536.

The fourth electrode 504 having a having a rectangular shape is provided on the fourth rectangular portion 538 of the first resistance body 506. The fourth electrode 504 is electrically connected to the fourth rectangular portion 538.

The length of the first resistance body 506 from the first front-surface extended portion 530 to the second front-surface extended portion 532 is shorter than the length of the thin-film resistance body 30 from the first thin-film extended portion 110 to the second thin-film extended portion 112. In addition, the width dimension of a region of the first resistance body 506 from the first front-surface extended portion 530 to the second front-surface extended portion 532 is narrower than the width dimension of a region of the thin-film resistance body 30 from the first thin-film extended portion 110 to the second thin-film extended portion 112.

With such a configuration, the first resistance body 506 and the thin-film resistance body 30 are set to have substantially the same resistance value.

### Second Resistance Body

As shown in FIG. 9, the second resistance body 514 is arranged on the back surface 26 that is a second surface of the substrate 20. The second resistance body 514 exhibits the same behavior as the thin-film resistance body 30.

The phrase “exhibits the same behavior” refers to that a temperature coefficient of resistance of the thin-film resistance body 30 and a temperature coefficient of resistance of the second resistance body 514 are substantially the same, and the resistance value change of the thin-film resistance body 30 and the resistance value change of the second resistance body 514 are substantially the same when the deformation is caused by the same load.

The phrase “the temperature coefficient of resistance is substantially the same” refers to that the difference between the temperature coefficient of resistance of the thin-film resistance body 30 and the temperature coefficient of resistance of the second resistance body 514 falls within a predetermined first range.

The first range is, for example, 100 ppm/K.

The phrase “the resistance value change is substantially the same” refers to that the difference between the change in the resistance value caused in the thin-film resistance body 30 and the change in the resistance value caused in the second resistance body 514 falls within a predetermined second range before and after a predetermined same load is applied to the thin-film resistance body 30 and the second resistance body 514.

A predetermined same load is, for example, 10 kN. In addition, the second range is, for example, 100 ppm.

The second resistance body 514 is made of the same material as the thin-film resistance body 30. In addition, the second resistance body 514 is formed on the substrate 20 by the same method as the thin-film resistance body 30.

The second resistance body 514 is arranged on the back side of the position where the thin-film resistance body 30 is arranged. In addition, the second resistance body 514 is formed to have substantially the same shape as the thin-film resistance body 30.

With such a configuration, the second resistance body 514 is arranged at the position overlapping with the thin-film resistance body 30 in the thickness direction 108 of the substrate 20. In addition, the second resistance body 514 is set so as to have substantially the same resistance value as the thin-film resistance body 30.

In the above, the phrase “the second resistance body 514 overlaps with the thin-film resistance body 30” does not exclude a case in which a non-overlapping region is formed at a part of an outer edge portion in a state in which the second resistance body 514 is superimposed on the thin-film resistance body 30 in the thickness direction 108 of the substrate 20.

The second resistance body 514 has: a first back-surface extended portion 540 that is arranged at the position overlapping with the first thin-film extended portion 110 of the thin-film resistance body 30 in the thickness direction 108 of the substrate 20; and a second back-surface extended portion 542 that is arranged at the position overlapping with a second thin-film extended portion 112. In addition, the second resistance body 514 has a back-surface joining portion 544 that is arranged at the position overlapping with the thin-film joining portion 114 of the thin-film resistance body

The second resistance body 514 has: a first back-surface widening portion 546 that is arranged at the position overlapping with the first widening portion 116 in the thickness direction 108 of the substrate 20; and a second back-surface widening portion 548 that is arranged at the position overlapping with the second widening portion 120 of the thin-film resistance body 30.

The second resistance body 514 has: a fifth rectangular portion 550 that is arranged at the position overlapping with the first rectangular portion 118 in the thickness direction 108 of the substrate 20; and a sixth rectangular portion 552 that is arranged at the position overlapping with the second rectangular portion 122 of the thin-film resistance body 30.

The fifth electrode 510 having a rectangular shape is provided on the fifth rectangular portion 550 of the second resistance body 514. The fifth electrode 510 is electrically connected to the fifth rectangular portion 550. In addition, the sixth electrode 512 having a rectangular shape is provided on the sixth rectangular portion 552 of the second resistance body 514. The sixth electrode 512 is electrically connected to the sixth rectangular portion 552.

A part of the first back-surface extended portion 540, the first back-surface widening portion 546, and the fifth rectangular portion 550 form a back-surface first end portion 554 of the second resistance body 514. A part of the second back-surface extended portion 542, the second back-surface widening portion 548, and the sixth rectangular portion 552 form a back-surface second end portion 556 of the second resistance body 514.

### Third Resistance Body

The third resistance body 524 is provided independently from the second resistance body 514. The third resistance body 524 exhibits the same behavior as the first resistance body 506.

In this embodiment, the term “behavior” means the change in the resistance value in response to the change in temperature, and the phrase “exhibits the same behavior” refers to that the temperature coefficient of resistance of the third resistance body 524 and the temperature coefficient of resistance of the first resistance body 506 are substantially the same.

The phrase “the temperature coefficient of resistances are substantially the same” refers to that the difference between the temperature coefficient of resistance of the third resistance body 524 and the temperature coefficient of resistance of the first resistance body 506 falls within a predetermined third range. The third range is, for example, 100 ppm/K.

The third resistance body 524 is made of the same material as the first resistance body 506. In addition, the third resistance body 524 is formed on the substrate by the same method as the first resistance body 506.

The third resistance body 524 is arranged on the back side of the position where the first resistance body 506 is arranged. In addition, the third resistance body 524 is formed to have substantially the same shape as the first resistance body 506.

With such a configuration, the third resistance body 524 is arranged at the position overlapping with the first resistance body 506 in the thickness direction 108 of the substrate 20. In addition, the third resistance body 524 is set so as to have substantially the same resistance value as the first resistance body 506.

In the above, the phrase “the third resistance body 524 overlaps with the first resistance body 506” does not exclude a case in which a non-overlapping region is formed at a part of an outer edge portion in a state in which the third resistance body 524 is superimposed on the first resistance body 506 in the thickness direction 108 of the substrate 20.

The third resistance body 524 has: a first back-side small extended portion 551 that is arranged at the position overlapping with the first front-surface extended portion 530 of the first resistance body 506 in the thickness direction 108 of the substrate 20; and a second back-side small extended portion 533 that is arranged at the position overlapping with the second front-surface extended portion 532. In addition, the third resistance body 524 has a back-side small joining portion 555 that is arranged at the position overlapping with the front-surface joining portion 534 of the first resistance body 506.

The third resistance body 524 has: a seventh rectangular portion 557 that is arranged at the position overlapping with the third rectangular portion 536 in the thickness direction 108 of the substrate 20; and a eighth rectangular portion 558 that is arranged at the position overlapping with the fourth rectangular portion 538 of the first resistance body 506.

The seventh electrode 520 having a rectangular shape is provided on the seventh rectangular portion 557 of the third resistance body 524. The seventh electrode 520 is electrically connected to the seventh rectangular portion 557. In addition, the eighth electrode 522 having a rectangular shape is provided on the eighth rectangular portion 558 of the third resistance body 524. The eighth electrode 522 is electrically connected to the eighth rectangular portion 558.

As shown in FIG. 7, a third lead wire 560 is connected to the third electrode 502 by the solder 130. A fourth lead wire 562 is connected to the fourth electrode 504 by the solder 130.

Similarly, a fifth lead wire 564 is connected to the fifth electrode 510 by the solder. A sixth lead wire 566 is connected to the sixth electrode 512 by the solder. A seventh lead wire 568 is connected to the seventh electrode 520 by the solder. An eighth lead wire 570 is connected to the eighth electrode 522 by the solder.

### Operations and Effects

Next, operational advantages achieved by the fifth embodiment will be described.

Also in this embodiment, for components that are the same as or equivalent to those in the first embodiment, it is possible to achieve operational advantages similar to those of the first embodiment.

In addition, in the load sensor element 500 of this embodiment, the first resistance body 506 having, at its end portions, the third electrode 502 and the fourth electrode 504 is provided on the front surface 22 that is the first surface of the substrate 20. The second resistance body 514 having, at its end portions, the fifth electrode 510 and the sixth electrode 512 and the third resistance body 524 having, at its end portions, the seventh electrode 520 and the eighth electrode 522 are provided on the back surface 26 that is the second surface of the substrate 20.

In this configuration, the load sensor element 500 includes the thin-film resistance body 30 and the first resistance body 506 that are provided on the front surface 22 of the substrate 20. In addition, the load sensor element 500 includes the second resistance body 514 and the third resistance body 524 that are provided on the back surface 26 of the substrate 20.

Therefore, a bridge circuit can be formed with four resistance bodies that are included in the load sensor element 500. In addition, by performing the measurement by using an output from the bridge circuit, it is possible to achieve highly precise measurement.

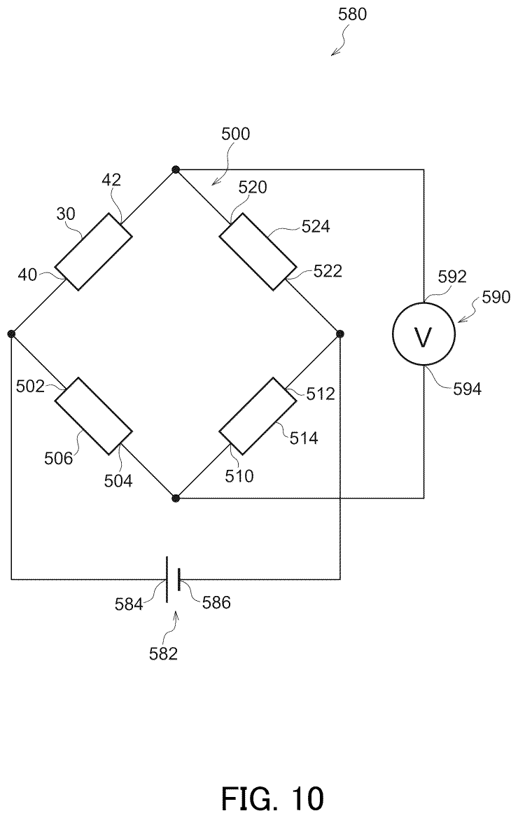

FIG. 10 is a circuit diagram showing a usage example of the load sensor element 500 according to the fifth embodiment. FIG. 10 shows a bridge circuit 580 that is formed by connecting the respective resistance bodies of the load sensor element 500.

There are many other types of the bridge circuit 580. FIG. 10 shows, as an example of the bridge circuit 580, a Wheatstone bridge circuit.

In the bridge circuit 580, the thin-film resistance body 30 that receives the load and the second resistance body 514 are provided on opposing sides. In addition, in the bridge circuit 580, the first resistance body 506 that does not receive the load and the third resistance body 524 are provided on opposing sides.

The first electrode 40 of the thin-film resistance body 30 and the third electrode 502 of the first resistance body 506 are connected to a positive electrode 584 of a power source 582. The sixth electrode 512 of the second resistance body 514 and the eighth electrode 522 of the third resistance body 524 are connected to a negative electrode 586 of the power source 582.

The second electrode 42 of the thin-film resistance body 30 and the seventh electrode 520 of the third resistance body 524 are connected to a first terminal 592 of a voltmeter 590. The fourth electrode 504 of the first resistance body 506 and the fifth electrode 510 of the second resistance body 514 are connected to a second terminal 594 of the voltmeter 590.

As described above, by forming the bridge circuit 580 with the respective resistance bodies 30, 506, 514, and 524 of the load sensor element 500, compared with a case in which only the change in the resistance value of the thin-film resistance body 30 is used as a measurement value, it is possible to increase the change in the output voltage. Therefore, even when the resistance value change of the single thin-film resistance body 30 is small, the output can be increased (amplified), and so, it becomes possible to achieve more accurate detection of the load and to improve measurement precision.

In addition, the bridge circuit 580 is formed of the four resistance bodies that are provided on the substrate 20 of the load sensor element 500. Therefore, compared with a case in which a bridge circuit is formed by using three external resistor in addition to the thin-film resistance body 30 of the load sensor element 500, it is possible to form the bridge circuit 580 only with the load sensor element 500. Thus, it is possible to make a space occupied by the bridge circuit 580 smaller and to reduce the size of a measurement device that is formed by using the bridge circuit 580.

Furthermore, compared with four resistors prepared individually, the four resistance bodies formed on the same substrate 20 have less variation in characteristics such as the resistance value, etc. of each resistance body. Therefore, by forming the bridge circuit 580 with the four resistance bodies that are formed on the substrate 20, it is possible to improve the precision of an output signal.

In addition, in this embodiment, the thin-film resistance body 30 on the front surface 22 side of the substrate 20 and the second resistance body 514 on the back surface 26 side of the substrate 20 have the same shape and are arranged at the positions overlapping with each other in the thickness direction 108 of the substrate 20. In addition, the first resistance body 506 on the front surface 22 of the substrate 20 side and the third resistance body 524 on the back surface 26 of the substrate 20 side have the same shape and are arranged at the positions overlapping with each other in the thickness direction 108 of the substrate 20.

Therefore, in the front surface 22 and the back surface 26 of the substrate 20, the formation states of the resistance bodies can be made same. Therefore, in the front surface 22 and the back surface 26 of the substrate 20, compared with a case in which the formation states of the resistance bodies are different, it is possible to suppress bias of the stress generated in the substrate 20.

The inorganic layer 24 and the reinforcing layer 28 are made of the material of the same type.

Therefore, it is possible to make the pressurizing condition under which the inorganic layer 24 pressurizes the thin-film resistance body 30 and the pressurizing condition under which the reinforcing layer 28 pressurizes the second resistance body 514 the same. As a result, it is possible to improve the precision of the measurement result obtained from the output of the bridge circuit 580.

In this embodiment, although the bridge circuit 580 is formed by using the thin-film resistance body 30 and the first resistance body 506 that are provided on the front surface 22 of the substrate 20 and the second resistance body 514 and the third resistance body 524 that are provided on the back surface 26, this embodiment is not limited thereto.

The four resistance bodies forming the bridge circuit 580 may be provided on the front surface 22, or the three resistance bodies excluding the thin-film resistance body 30 may be provided on the back surface 26, and this embodiment does not exclude these configurations.

### Sixth Embodiment

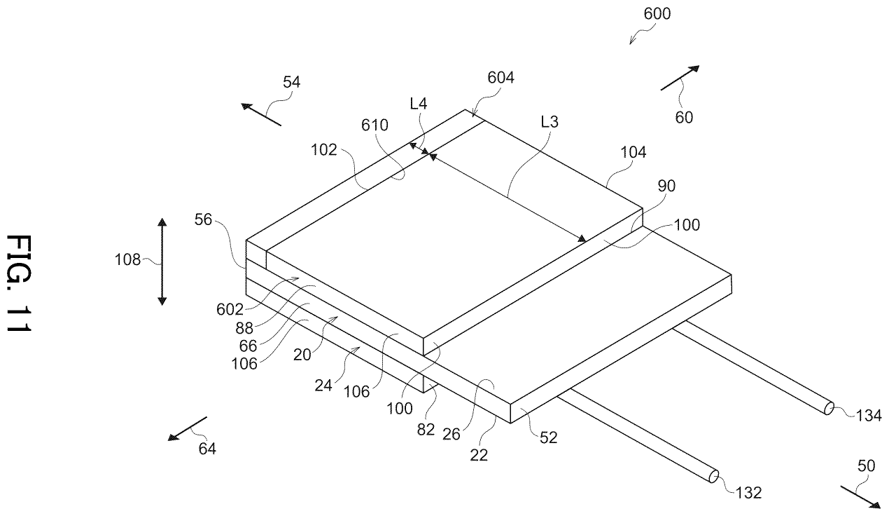

A load sensor element 600 according to a sixth embodiment will be described with reference to FIG. 11. In this embodiment, components that are the same as or equivalent to those in the first embodiment are assigned the same reference numerals as the first embodiment, and a description thereof shall be omitted and only differences from those in the first embodiment will be described.

FIG. 11 is a perspective view of the load sensor element 600 according to the sixth embodiment viewed from the back surface side. Compared with the first embodiment, the load sensor element 600 according to the sixth embodiment is different in the state of the back surface 26 of the substrate 20.

In the load sensor element 600, at least one of an edge of the inorganic layer 24 serving as the first layer and an edge of an reinforcing layer 602 serving as the second layer comes into contact with a projected portion 604 that is provided on the substrate 20. In the load sensor element 600 according to this embodiment, the edge of the reinforcing layer 602 is in contact with the projected portion 604 that is provided on the substrate 20.

Specifically, the projected portion 604 is formed on the back surface 26 of the substrate 20. The projected portion 604 is formed of a projected ridge, and the cross-section of the projected portion 604 is substantially rectangular. The projected portion 604 has substantially the same thickness dimension as the reinforcing layer 602.

The projected portion 604 is provided on the second direction side 54 of the substrate 20. The projected portion 604 extends along the substrate second end edge 56. The projected portion 604 has a length that reaches the substrate second side edge 66 from the substrate first side edge 62 (not shown).

The projected portion 604 is made of, for example, a synthetic resin. The projected portion 604 is formed accurately at a position of the substrate 20 by, for example, a printing technique. The printing technique includes a screen printing, for example.

The reinforcing-layer second end edge 102 of the reinforcing layer 602 is in contact with the entire length of a projected-portion first end edge 610 of the projected portion 604 on the first direction side 50. The reinforcing layer 602 is aligned by the projected portion 604. As a result, the reinforcing-layer first end edge 100 of the reinforcing layer 602 is arranged above the boundary line 90, and the reinforcing-layer first end edge 100 and the inorganic-layer first end edge 82 of the inorganic layer 24 are overlapped in the thickness direction 108.

Compared with the reinforcing layer 28 of the first embodiment, the reinforcing layer 602 has the length dimension L3 that is shorter by the length dimension L4 of the projected portion 604.

In this embodiment, although a description has been given of a case in which the projected portion 604 is provided on the back surface 26 of the substrate 20, and the reinforcing-layer second end edge 102 of the reinforcing layer 602 is brought into contact with the projected-portion first end edge 610 of the projected portion 604, this embodiment is not limited thereto. For example, a projected portion may be provided on the front surface 22 of the substrate 20, and an edge of the inorganic layer 24 may be brought into contact with the projected portion.

In addition, the reinforcing-layer second end edge 102 of the reinforcing layer 602 may be brought into contact with the projected portion 604, and an edge of the inorganic layer 24 may be brought into contact with a projected portion formed on the front surface 22.

### Operations and Effects

Next, operational advantages achieved by the sixth embodiment will be described.

Also in the load sensor element 600 of this embodiment, for components that are the same as or equivalent to those in the first embodiment, it is possible to achieve operational advantages similar to those of the first embodiment.

In addition, in the load sensor element 600 of this embodiment, at least one of the edge of the inorganic layer 24 serving as the first layer and the edge of the reinforcing layer 602 serving as the second layer is brought into contact with the projected portion 604 that is provided on the substrate 20.

In the load sensor element 600 having such a configuration, for example, by fixing the reinforcing layer 602 to the substrate 20 by aligning the reinforcing-layer second end edge 102 of the reinforcing layer 602 with the projected portion 604 that is formed on the substrate 20 in advance at the time of manufacturing, it is possible to arrange the reinforcing-layer first end edge 100 above the boundary line 90.

Specifically, after the inorganic-layer first end edge 82 of the inorganic layer 24 is aligned and fixed on the boundary line 90, the reinforcing layer 602 is fixed in a state in which the reinforcing-layer second end edge 102 of the reinforcing layer 602 is brought into contact with the projected portion 604. As a result, it becomes possible to arrange the reinforcing layer 602 such that the reinforcing-layer first end edge 100 of the reinforcing layer 602 and the inorganic-layer first end edge 82 of the inorganic layer 24 are overlapped in the thickness direction 108.

Therefore, compared with a case in which the reinforcing layer 602 needs to be accurately aligned when it is to be fixed to the substrate 20, it is possible to make the alignment of the reinforcing layer 602 relative to the inorganic layer 24 easier.

Although the present embodiment has been described in the above, the above-described embodiments merely illustrate a part of application examples of the present invention, and the technical scope of the present invention is not intended to be limited to the specific configurations of the above-described embodiments.

The present application claims priority to Japanese Patent Application No. 2022-050869, filed in the Japan Patent Office on Mar. 25, 2022. The contents of this application are incorporated herein by reference in their entirety.

### EXPLANATION OF REFERENCE

10, 200, 300, 400, 500, 600 load sensor element
20, 410 substrate
22 front surface
24 inorganic layer
26 back surface
28, 602 reinforcing layer
30 thin-film resistance body
32 main body portion
34, 70 exposed portion
36, 420 first end portion
38, 422 second end portion
40 first electrode
42 second electrode
50 first direction side
52 substrate first end edge
54 second direction side
80 pressure receiving surface
82 inorganic-layer first end edge
90 boundary line
100 reinforcing-layer first end edge
108 thickness direction
412 first exposed portion
414 second exposed portion
416 first boundary line
418 second boundary line
502 third electrode
504 fourth electrode
506 first resistance body
510 fifth electrode
512 sixth electrode
514 second resistance body
520 seventh electrode
522 eighth electrode
524 third resistance body
554 back-surface first end portion
556 back-surface second end portion
604 projected portion
T1, T2 thickness dimension

1-8. (canceled)

9. A load sensor element for measuring a surface pressure load comprising:
a substrate;
a first layer provided on a first surface of the substrate, the first layer being configured to cover a part of the substrate;
a thin-film resistance body formed of a resistance body whose resistance value is changed in response to a load received from the first layer, the thin-film resistance body having: a main body portion provided on the first surface of the substrate and sandwiched between the substrate and the first layer; and both end portions arranged on an exposed portion of the substrate, the exposed portion being not covered by the first layer;
a pair of electrodes respectively electrically connected to both end portions of the thin-film resistance body; and
a second layer provided on a second surface of the substrate so as to sandwich the substrate together with the first layer; wherein
the first layer and the second layer are arranged such that an edge of the first layer on at least one side in contact with the first surface of the substrate and an edge of the second layer on at least one side in contact with the second surface are aligned with each other in a thickness direction of the substrate.

10. The load sensor element according to claim 9, wherein
the first layer has substantially same size as the second layer.

11. The load sensor element according to claim 9, wherein
a thickness dimension of the second layer is larger than a thickness dimension of the first layer.

12. The load sensor element according to claim 9, further comprising
an outer layer having a lower elastic modulus than the substrate on at least one of an outer surface of the first layer and an outer surface of the second layer.

13. The load sensor element according to claim 9, wherein
the exposed portion has a first exposed portion formed on a first side portion of the substrate and a second exposed portion formed on a second side portion of the substrate,
a first-side end portion of the thin-film resistance body is arranged on the first exposed portion, and a second-side end portion of the thin-film resistance body is arranged on the second exposed portion, and
the pair of electrodes include a first electrode provided on the first-side end portion and a second electrode provided on the second-side end portion.

14. The load sensor element according to claim 9, wherein
a first resistance body having, at its end portions, a third electrode and a fourth electrode is provided on the first surface of the substrate, and
a second resistance body having, at its end portions, a fifth electrode and a sixth electrode and a third resistance body having, at its end portions, a seventh electrode and a eighth electrode are provided on the second surface.

15. The load sensor element according to claim 9, wherein
the first layer and the second layer are made of a material of same type.

16. The load sensor element according to claim 9, wherein
at least one of the edge of the first layer and the edge of the second layer is in contact with a projected portion provided on the substrate.
